(19) United States
(12) Patent Application Publication
(10) Pub. No.: US 2018/0083490 A1
(43) Pub. Date: Mar. 22, 2018

(54) Single-Isolation Wireless Power Converter

(71) Applicant: Apple Inc., Cupertino, CA (US)

(72) Inventors: InHwan Oh, Cupertino, CA (US); Manisha P. Pandya, Saratogo, CA (US); Abby Cherlan, Fremont, CA (US); Bharat K. Patel, San Jose, CA (US)

(21) Appl. No.: 15/711,182

(22) Filed: Sep. 21, 2017

Related U.S. Application Data
(60) Provisional application No. 62/398,207, filed on Sep. 22, 2016.

(51) Int. Cl. H02J 50/12; H04B 5/00; H02J 5/00

(52) U.S. Cl. CPC H02J 50/12; H02J 5/005; H04B 5/0093; H04B 5/0037

(57) ABSTRACT

A power converter can be implemented as a series of power conversion stages, including a wireless power conversion stage. In typical embodiments, the power converter receives power directly from mains voltage and outputs power to a battery within an electronic device. A transmitter side of the power converter converts alternating current received from a power source (e.g., mains voltage) to an alternating current suitable for applying to a primary coil of the wireless power conversion stage of the power converter.

### CROSS-REFERENCE TO RELATED APPLICATION

This application is a non-provisional patent application of, and claims the benefit to, U.S. Provisional Patent Application No. 62/398,207, filed Sep. 22, 2016, and titled “Single-Isolation Wireless Power Converter,” the disclosure of which is hereby incorporated herein by reference in its entirety.

### FIELD

Embodiments described herein generally relate to power converters and, in particular, to single-isolation wireless power converters that can be accommodated in low-profile enclosures.

### BACKGROUND

A power converter is typically implemented as series of independent power conversion or isolation stages interposing a power source and a load. In some cases, a power converter can include a wireless power transfer stage that transfers power to the load across an air gap by inducing a current in a coil coupled to the load. Such power converters can be referred to as “wireless power converters.”

A typical wireless power converter is configured to receive regulated direct current from a power adapter coupled to and galvanically isolated from mains voltage. This configuration requires a large number of power conversion stages and isolation stages between the power source (e.g., mains voltage) and the load, each of which contributes to aggregate apparent power loss (e.g., conduction losses, switching losses, eddy current losses, and so on) and reduced power factor.

### SUMMARY

Embodiments described herein generally reference a power converter implemented as a series of power conversion stages, including a wireless power conversion stage. In typical embodiments, the power converter receives power directly from mains voltage and outputs power to a battery within an electronic device.

In some embodiments, the power converter includes a rectifier stage accommodated within a low-profile enclosure and configured to receive mains voltage. The power converter also includes a step-down voltage converter stage (e.g., buck converter) accommodated within the enclosure. The step-down voltage converter is configured to receive a rectified voltage from the rectifier stage. The power converter also includes an inverter stage accommodated within the enclosure. The inverter stage is configured to receive a lowered regulated voltage from the step-down voltage converter stage. Finally, the power converter also includes a wireless power transfer stage. The wireless power transfer stage includes a primary coil accommodated within the enclosure and configured to receive an alternating current from the inverter stage. In these embodiments, the inverter is configured to operate at a fixed switching frequency, although this may not be required of all embodiments.

### BRIEF DESCRIPTION OF THE DRAWINGS

Reference will now be made to representative embodiments illustrated in the accompanying figures. It should be understood that the following descriptions are not intended to limit this disclosure to one preferred embodiment. To the contrary, the disclosure provided herein is intended to cover alternatives, modifications, and equivalents as may be included within the spirit and scope of the described embodiments, and as defined by the appended claims.

FIG. 1A depicts a power converter including a wireless power transfer stage.

FIG. 1B depicts a side view of the power converter of FIG. 1A.

FIG. 2 is a simplified system diagram of a power converter—including a wireless power transfer stage—that receives alternating current from a power source.

FIG. 3A is a simplified schematic diagram of a transmitter side of a wireless power converter, such as described herein.

FIG. 3B is a simplified schematic diagram of a receiver side of a wireless power converter, such as the wireless power converter depicted in FIG. 3A.

FIG. 3C is a simplified schematic diagram of another receiver side of a wireless power converter, such as the wireless power converter depicted in FIG. 3A.

FIG. 4A is a simplified schematic diagram of a peak-current controller that can be used with the power converter depicted in FIG. 3A.

FIG. 4B is a signal diagram depicting constant peak current control operation of the peak-current controller depicted in FIG. 4A.

FIG. 4C is a signal diagram depicting periodic peak current control operation of the peak-current controller depicted in FIG. 4A.

FIG. 5 is a simplified flow chart corresponding to a method of operating a power converter including a wireless power transfer stage, such as described herein.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein reference systems and methods for operating a power converter in a manner that efficiently converts electric power received from a power source into voltage and/or current levels usable by a load, such as a portable electronic device.

As used herein, the phrase “power converter” generally refers to an implementation-specific combination or order of “power conversion stages” that are directly or indirectly electrically coupled to one another. The various power conversion stages of a power converter such as described herein cooperate to convert power received from a power source to power safely usable by a load. Example power conversion stages that can be associated with a power converter such as described herein can include filter stages, rectifier stages, inverter stages, step-up or step-down voltage conversion stages, wireless power transfer stages, battery charging stages, and so on.

For simplicity of description, the embodiments that follow reference a power converter that receives power input directly from mains voltage (e.g., 90 VAC-265 VAC at 50-60 Hz) and provides power output—across a wireless power transfer stage—to a variable resistive load within a portable electronic device. Such a system is generally referred to herein as a “wireless power converter.”

Generally and broadly, a wireless power converter such as described herein converts unregulated and/or noisy mains voltage to a low-voltage direct current usable by a battery-powered portable electronic device. The wireless power converter includes at least one wireless power transfer stage, including a primary coil and a secondary coil separated by a gap. An alternating current is applied to the primary coil, which induces a corresponding alternating current in the secondary coil.

In these embodiments, the wireless power converter is functionally and structurally divided into two portions that are electrically and physically isolated from one another by the gap. In many embodiments, the gap serves as a single, consolidated, galvanic isolation for the wireless power converter, isolating mains voltage from the portable electronic device. As a result of this configuration, the wireless power converter can be appropriately and safely implemented with fewer—and smaller—components.

For simplicity of description, the separated portions of a wireless power converter such as described herein are referred to herein as the “transmitter side” and the “receiver side.” The transmitter side receives mains voltage (e.g., high-voltage, low-frequency alternating current) and converts that voltage to an alternating current suitable to apply to the primary coil of the wireless power transfer stage (e.g., low-voltage high-frequency alternating current).

More specifically, the transmitter side of the wireless power converter is coupled directly to mains voltage and is accommodated in a single enclosure; an intermediate or separate external power adapter is not required. Similarly, the receiver side of the wireless power converter receives a low-voltage, high-frequency alternating current from the secondary coil (induced by the primary coil) and converts that current into a low-voltage direct current suitable to drive a load (e.g., 3.3 VDC, 5.0 VDC, 12 VDC, 50 VDC, and so on).

In some embodiments, the transmitter side is implemented with a rectifier, a buck converter, and a resonant inverter coupled to the primary coil of the wireless power transfer stage. The rectifier receives unregulated alternating current (e.g., mains voltage) and outputs a rippled direct current that is periodic and in-phase with the unregulated alternating current input.

The buck converter receives the rippled direct current from the rectifier and outputs a lower-voltage, regulated, direct current. The resonant inverter receives the lower-voltage direct current from the buck converter and outputs a high-frequency alternating current. In this manner, the transmitter side can be classified as an AC-to-AC power converter. This configuration may be more operationally efficient, and can be accommodated in a more compact enclosure, than a conventional wireless power converter that couples to a power adapter and requires additional power conversion stages and isolation stages such as, but not limited to: step-up voltage conversion stages (e.g., boost converters), large-size low-frequency transformer stages, high-frequency rectification stages, high-voltage inverter stages, and so on.

In further embodiments, the buck converter of the transmitter side is operated with peak-current control. More specifically, the current output from the buck converter is limited to not exceed a selected maximum. In some embodiments, the selected maximum current is fixed whereas in other embodiments, the selected maximum current is periodic and in-phase with the unregulated alternating voltage input to the rectifier. In this manner, the buck converter—or more generally, the transmitter side—approaches unity power factor.

In some embodiments, the receiver can be implemented with the secondary coil of the wireless power transfer stage, a rectifier, a compensation network and/or filter, and a load. As with the transmitter side, the rectifier of the receive side receives alternating current from the secondary coil and outputs a rippled direct current. The compensation network or filter receives the rippled direct current from the rectifier and outputs a regulated direct current which can be applied to the load.

In these embodiments, the primary coil and the secondary coil are configured to resonate at the same frequency. In many cases, this frequency is fixed, although such a configuration may not be required of all embodiments; a variable switching frequency can be used. In these examples, zero voltage switching can be achieved; switching losses associated with the transmitter side and switching losses associated with the receiver side can be mitigated or eliminated, thereby increasing the efficiency of power conversion from mains voltage to the load.

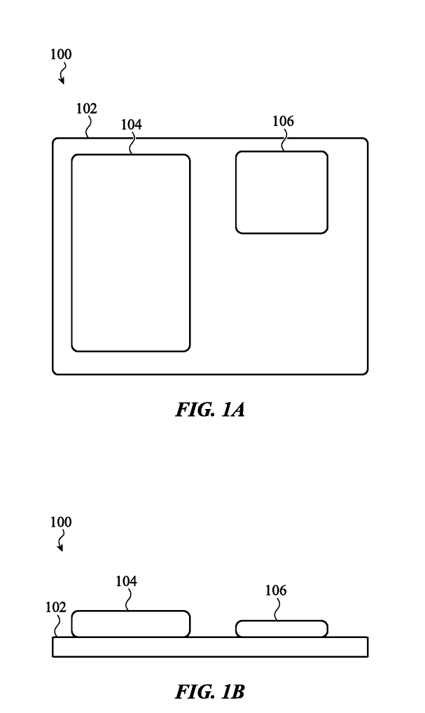

These and other embodiments are discussed below with reference to FIGS. 1A-5. However, those skilled in the art will readily appreciate that the detailed description given herein with respect to these figures is for explanation only and should not be construed as limiting.

Generally and broadly, FIGS. 1A-1B depict a wireless power converter including a transmitter side and a receiver side incorporated in separate housings. It will be appreciated, however, that the depicted examples are not exhaustive; the various embodiments described with reference to FIGS. 1A-1B may be modified or combined in any number of suitable or implementation-specific ways.

In particular, FIG. 1A depicts a wireless power converter 100 which, as noted above, is a power converter that includes at least one wireless power transfer stage. FIG. 1B depicts a side view of the wireless power converter 100, specifically illustrating an example embodiment in which a transmitter side of the wireless power converter 100 is accommodated in a low-profile (e.g., thin) enclosure. The enclosure can be formed from any number of materials including, but not limited to: plastic, glass, sapphire, metal, acrylic materials, polycarbonate materials, and so on or any combination thereof.

The wireless power converter 100 includes a wireless power transfer stage. As noted above, a wireless power transfer stage functionally and structurally divides the wireless power converter 100 into (at least) two portions—a transmitter side and a receiver side. The transmitter side of the wireless power converter 100 includes one or more primary coils and the receiver side of the wireless power converter 100 includes one or more secondary coils.

The transmitter side—and in particular, the primary coil(s) of the wireless power transfer stage—is accommodated in a low-profile enclosure 102. As used herein the phrase, “low-profile enclosure” is generally understood to refer to an enclosure having a generally flat and planar profile with maximum thickness that is substantially less than a width or a length of the enclosure. For example, in some embodiments, a low-profile enclosure has a thickness that is less, or equal to, approximately 1.0 cm.

The low-profile enclosure 102 can also accommodate, enclose, and/or support a processor, memory, display, battery, network connections, sensors, input/output ports, acoustic elements, haptic elements, digital and/or analog circuits for performing and/or coordinating tasks of the wireless power converter 100, and so on. For simplicity of illustration, the low-profile enclosure 102 is depicted in FIG. 1A without many of these elements, each of which may be included, partially and/or entirely, within the low-profile enclosure 102 and may be operationally or functionally associated with the transmitter side of the wireless power converter 100. In some embodiments, the transmitter side is fully-integrated; all components of the transmitter side of the wireless power converter 100 are enclosed within the low-profile enclosure 102, apart from an electrical connection (e.g., cable) to mains voltage, which is not depicted in FIGS. 1A-1B.

The wireless power converter 100 also includes a receiver side. The receiver side—and in particular, the secondary coil(s) of the wireless power transfer stage—is accommodated and enclosed within an enclosure 104. Typically, the enclosure 104 is smaller than the low-profile enclosure 102, but this may not be required of all embodiments. As with the low-profile enclosure 102, the enclosure 104 can also accommodate a processor, memory, display, battery, network connections, sensors, input/output ports, acoustic elements, haptic elements, digital and/or analog circuits for performing and/or coordinating tasks of the wireless power converter 100 or another electronic device, and so on. For simplicity of illustration, the enclosure 104 is depicted in FIG. 1A without many of these elements, each of which may be included, partially and/or entirely, within the enclosure 104 and may be operationally or functionally associated with the receiver side of the wireless power converter 100.

In some examples, the enclosure 104 is an enclosure of an electronic device such as a cellular phone, a tablet computer, a wearable electronic device (e.g., watch, pendant, bracelet, necklace, anklet, ring, and so on), a peripheral input device (e.g., keyboard, mouse, trackpad, remote control, stylus, gaming device, gesture input device, and so on), an authentication device or token, and so on. In many cases, the wireless power converter 100, and in particular the receiver side of the wireless power transfer stage of the wireless power converter 100, is a portion of the electronic device and is configured to deliver power to a rechargeable battery within the enclosure 104.

As noted above, the wireless power converter 100 can be implemented with more than one primary coil and more than one secondary coil. In some examples, more than one secondary coil can be accommodated in the enclosure 104, but this may not be required. For example, in one embodiment, the wireless power converter 100 further includes a second receiver side, accommodated within a second enclosure 106.

As with the enclosure 104, the second enclosure 106 can be smaller than the low-profile enclosure 102, but this may not be required. The second enclosure 106, as with the enclosure 104, is configured to accommodate one or more secondary coils associated with the second receive side of the wireless power transmitter 100. In addition to the secondary coil(s), the secondary enclosure 106 can also accommodate a processor, memory, display, battery, network connections, sensors, input/output ports, acoustic elements, haptic elements, digital and/or analog circuits for performing and/or coordinating tasks of the wireless power converter 100 or another electronic device, and so on. For simplicity of illustration, the secondary enclosure 106 is depicted in FIG. 1A without many of these elements, each of which may be included, partially and/or entirely, within the secondary enclosure 106 and may be operationally or functionally associated with the second receiver side of the wireless power converter 100. As with the enclosure 104, the secondary enclosure 106 can be the enclosure of an electronic device.

In the illustrated embodiment, the low-profile enclosure 102 that encloses the transmitter side of the wireless power converter 100 defines an interface surface on which the enclosure 104 and the second enclosure 106 can rest. The interface surface can be substantially planar, although this is not required. For example, in some embodiments, the interface surface may be concave, convex, patterned, or may take another shape.

As noted above, in many examples, the transmitter side of the wireless power converter 100 includes more than one primary coil. In these embodiments, individual primary coils can be associated with different portions of the interface surface. In this manner, the wireless power converter 100 can selectively activate or deactivate primary coils independently. Further, the wireless power converter 100 can selectively control power output from each primary coil independently. In many cases, the wireless power converter 100 can selectively active a primary coil (or more than one primary coil) based on the position and/or orientation of the enclosure 104 and/or the second enclosure 106 relative to the interface surface and, in particular, relative to the location of a nearby primary coil. More specifically, the wireless power converter 100 can selectively activate a primary coil and/or disable one or more other primary coil(s) based on a coupling factor k that corresponds to the mutual coupling between the selected primary coil and a secondary coil disposed within the enclosure 104 or the second enclosure 106; the higher the coupling factor, the more likely the wireless power converter 100 is to activate that primary coil to effect power transfer from that primary coil to the secondary coil within the enclosure 104 or the second enclosure 106.

The foregoing embodiments depicted in FIGS. 1A-1B and the various alternatives thereof and variations thereto are presented, generally, for purposes of explanation, and to facilitate an understanding of various possible electronic devices or accessory devices that can incorporate, or be otherwise associated with, a wireless power converter, such as described herein. However, it will be apparent to one skilled in the art that some of the specific details presented herein may not be required in order to practice a particular described embodiment, or an equivalent thereof.

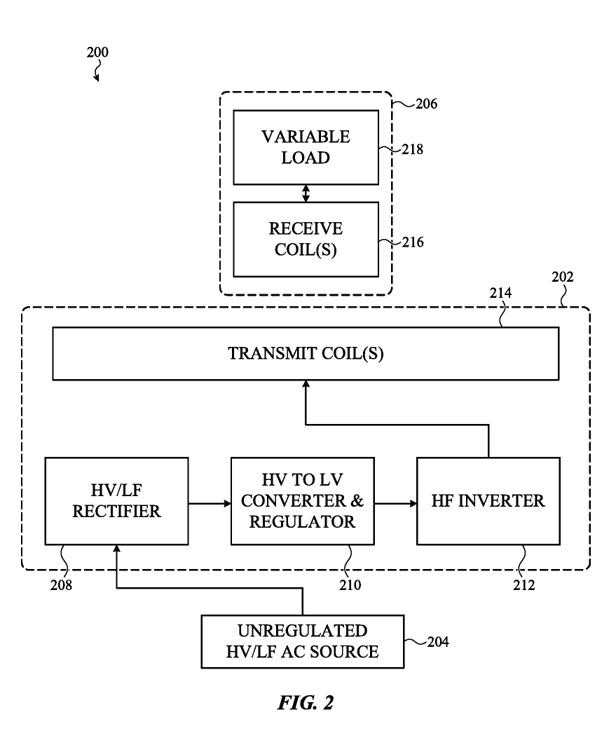

FIG. 2 depicts a wireless power converter 200 that includes a transmitter side 202 that is directly coupled to a power source 204. The wireless power converter 200 also includes a receiver side 206.

As with other embodiments described herein, the power source 204 outputs unregulated or otherwise noisy (or variable) alternating current at a high voltage and a low frequency. For example, the power source 204 may be configured to output mains voltage that can vary from 90.0 VAC to 265 VAC and may vary from 50 Hz to 60 Hz.

The transmitter side 202 of the wireless power converter 200 is fully-integrated in a single housing configured to accommodate a rectifier stage 208, a voltage converter stage 210, and a high-frequency inverter stage 212.

The rectifier stage 208 of the transmitter side 202 is configured to receive the unregulated high-voltage, low-frequency alternating current output from the power source 204 (e.g., ˜90 VAC to ˜265 VAC at 50 Hz to 60 Hz or another suitable voltage or frequency). The rectifier stage 208 is configured to output high-voltage rippled direct current (e.g., ˜80 VDC to ˜400 VDC, rippled, or another suitable voltage). The rectifier stage 208 can be a half-bridge rectifier or a full-bridge rectifier.

The voltage converter stage 210 of the transmitter side 202 is configured to receive the rectified high-voltage rippled direct current output from the rectifier stage 208 and outputs a low-voltage direct current. In some cases, the voltage converter stage 210 is a resonant buck converter, but this may not be required.

The high-frequency inverter stage 212 receives the lower-voltage direct current from the voltage converter stage 210 and outputs a high-frequency alternating current. More specifically, the high-frequency inverter stage 212 repeatedly toggles the conduction state of a voltage-controlled switch interposing the output of the voltage converter stage 210 and a resonant tank circuit. In these embodiments, one or more of the primary coils 214 serve as a portion of the resonant tank. In this manner, the transmitter side 202 can be referred to as an AC-to-AC power converter.

The primary coils 214 of the transmitter side 202 are each configured to receive the high-frequency, lower-voltage alternating current output (e.g., ˜100 VAC at 130 kHz to 230 kHz, or another suitable voltage or frequency) from the high-frequency inverter stage 212. As with other embodiments described herein, a single primary coil can be activated at a time whereas in other embodiments, multiple transmit coils can be activated simultaneously. In many cases, one or more of the primary coils 214 are configured to resonate. In many cases, the primary coils 214 are configured to resonate at the frequency of the high-frequency, lower-voltage alternating current output received from the high-frequency inverter stage 212.

The receiver side 206 of the wireless power converter 200 includes one or more secondary coils and one or more variable loads. In the illustrated embodiment, the receiver side 206 includes the secondary coil(s) 216 and a variable load 218.

As noted with respect to other embodiments described herein the receiver side(s) of the wireless power converter 200 can be implemented in any suitable manner and/or can be bodily incorporated into any suitable electronic device. In one embodiment, the receiver side 206 is associated with a cellular phone or a wearable electronic device.

The secondary coils 218 of the receiver side 206 are each configured to receive the high-frequency, lower-voltage alternating current from the primary coils 214 (via mutual induction). The variable load 220 of the receiver side 206 is configured to receive high-frequency, lower-voltage alternating current from the secondary coils 218. In many cases, the variable load 220 further converts the high-frequency, lower-voltage alternating current to direct current. For example, the variable load 220 can include a rectifier (e.g., synchronous or passive) that rectifies the lower-voltage alternating current received from the secondary coils 218.

The foregoing embodiment depicted in FIG. 2 and the various alternatives thereof and variations thereto are presented, generally, for purposes of explanation, and to facilitate a thorough understanding of various possible configurations of a wireless power converter. In some embodiments, the transmitter side includes two separately-implemented portions, one that configured to convert poorly-regulated mains voltage to regulated high-frequency low-voltage, and one that is configured to energize a primary coil of a wireless power transfer stage of the wireless power converter. In other cases, the embodiment depicted in FIG. 2 can include a fully-integrated transmit side. As such, it is appreciated that the various specific examples presented above are not intended to be an exhaustive list of potential configurations of a wireless power converter, such as described herein.

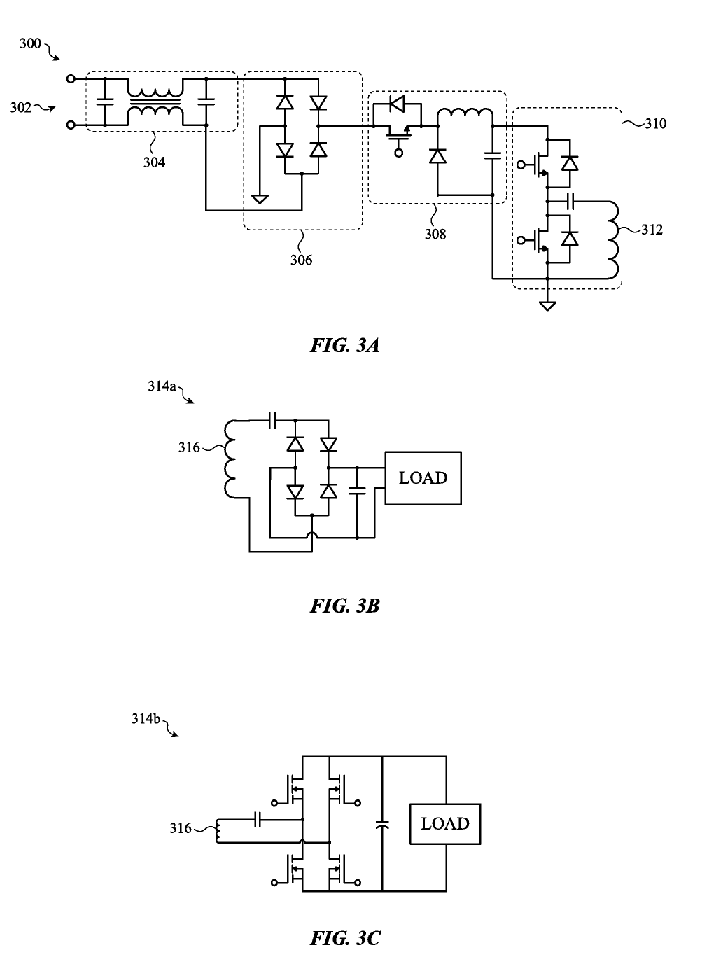

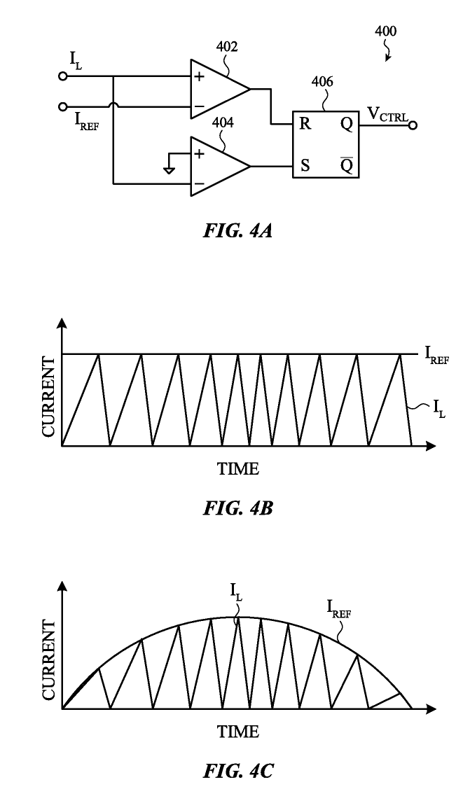

Generally and broadly, FIGS. 3A-4C reference a transmitter side of a wireless power converter, such as described herein. In these embodiments, the transmitter side receives unregulated and/or noisy low-frequency high-voltage power directly from a power source (e.g. mains voltage). The transmitter side includes a buck converter (or other suitable step-down voltage converter) that is configured reduce and regulate the low-frequency high-voltage to a lower direct current voltage level. The output of the buck converter is then coupled to a high frequency inverter operated at a fixed switching frequency or a variable switching frequency. The inverter serves as the primary coil of the wireless power transfer stage. The inverter can be magnetically coupled to a secondary coil (see, e.g., FIGS. 3B-3C) of the same wireless power transfer stage. In this example, the wireless power transfer stage is configured to resonate at a fixed frequency that is selected to minimize gain variation across the wireless power transfer stage.

More specifically, the resonant frequency of the primary coil and the secondary coil of the wireless power transfer stage can be selected for optimal performance at a wide variety of coupling factors (e.g., poor coupling between the primary coil and the secondary coil, good coupling between the primary coil and the secondary coil, ideal coupling between the primary coil and the secondary coil, and so on) and at a wide variety of load impedance across the leads of the secondary coil.

In other words, the embodiment described in reference to FIGS. 3A-4C can effectively convert unregulated and/or noisy alternating current received in a transmitter side of a wireless power conversion system to well-regulated direct current within a receiver side of the same system. Although this implementation does not expressly require load impedance feedback from the receiver side, or large size bulk capacitors, or large-size output capacitors, or large-size voltage transformers, any feedback information obtained from receiver side (through any suitable method) can be used to augment or control power output from the transmitter side. Further, as a result of the various constructions and embodiments described herein, a wireless power conversion system can efficiently convert unregulated alternated current to well-regulated direct current (in a manner that is minimally impacted by loading of the secondary coil and in a manner that is minimally impacted by changes in the quality of the coupling between the primary coil and the secondary coil) while being accommodated in a low-profile housing.

Specifically, FIG. 3A depicts a simplified schematic diagram of a power converter 300 including a wireless power transfer stage, such as described herein. The power converter 300 is transmitter side of a wireless power converter. As such, it is appreciated that any suitable receiver side, such as the receiver side 206 depicted in FIG. 2, can be configured to operate with the power converter 300.

The power converter 300 includes input terminals (identified as the input terminals 302) to receive unregulated and/or noisy high-voltage, low-frequency alternating current from a power source, such as mains voltage. The power converter 300 can include an electromagnetic interference filter stage 304 to reduce powerline noise present in the high-voltage, low-frequency alternating current received at the input terminals 302. An output of the electromagnetic interference filter stage 304 is coupled to an input of a rectifier stage 306.

The rectifier stage 306 is configured to output high-voltage rippled direct current. An output of the rectifier stage 306 is coupled to an input of a step-down voltage converter stage 308. In many embodiments, the step-down voltage converter stage 308 is implemented with a buck converter topology, but this is not required. For example, in some embodiments a boost topology or a boost-buck topology can be used. More generally, any suitable direct current to direct current converter can be used as the step-down voltage converter stage 308 (to increase or decrease voltage) to regulate the output voltage from the unregulated direct current voltage output from the rectifier stage 306.

In this example, a buck converter can include a tank inductor and an output capacitor. A low-side lead of the tank inductor is coupled to a high-side lead of the output capacitor, which, in turn, is connected in parallel to an output ground lead of the buck converter. The output leads of the buck converter are typically connected to a high-frequency inverter, identified as the resonant inverter stage 310, described in greater detail below.

A return diode couples a low-side lead of the output capacitor of the buck converter to a high-side lead of the tank inductor. The buck converter also includes a voltage-controlled switch (e.g., a power MOSFET) that couples the high-side lead of the tank inductor to an input lead of the buck converter. The input lead of the buck converter receives the input voltage, which in the illustrated example is the rippled direct current output from the rectifier stage 306.

The buck converter can be switched between an on-state and an off-state by toggling the voltage-controlled switch. The buck converter topology described above is referred herein as a “high-side” buck converter as a consequence of the direct connection between the voltage-controlled switch and the input voltage received from the rectifier stage 306.

When a high-side buck converter is in the on-state, the voltage-controlled switch is closed and a first current loop is defined from the input voltage source, through the tank inductor, to the resonant inverter stage 310. In this state, voltage across the tank inductor sharply increases to a voltage level equal to the difference between the instantaneous voltage across the resonant inverter stage 310 and the input voltage received from the rectifier stage 306. This voltage across the tank inductor induces current through the tank inductor to linearly increase. As a result of the topology of the depicted circuit, the current flowing through the tank inductor also flows to the output capacitor and to the resonant inverter stage 310.

Alternatively, when the high-side buck converter transitions to the off-state, the voltage-controlled switch is opened and a second current loop is defined through the return diode. In this state, voltage across the tank inductor sharply decreases to a voltage level equal to the difference between the voltage across the output leads of the buck converter and the cut-in voltage of the return diode. This voltage across the tank inductor is lower than when in the on-state, so current within the tank inductor linearly decreases in magnitude. The decreasing current flowing through the tank inductor also flows to the output capacitor and to the resonant inverter stage 310 connected across the output leads of the buck converter. In this manner, the output capacitor functions as a low-pass filter, generally reducing ripple in the voltage delivered from the output of the buck converter to the resonant inverter stage 310.

The buck converter can be efficiently operated by switching between the on-state and the off-state by toggling the voltage-controlled switch at a duty cycle selected based on the desired voltage applied across the resonant inverter stage 310. The voltage output from the buck converter is proportionately related to the input voltage by the duty cycle. For continuous inductor current operation, this relationship can be modeled by Equation 1:

D_{cycle}=Vₒᵤₜ/Vₒᵤₜ Equation 1

In one example, if direct current output from the rectifier stage 306 is 120 VDC (rippled) and the desired output voltage is 40 VDC, a duty cycle of 33% may be selected (if the inductor current is operated in a continuous mode).

In many cases, the buck converter is operated in a discontinuous conduction mode, although this may not be required. More particularly, if the buck converter is operated in a discontinuous conduction mode, current through the tank inductor regularly reaches 0.0 A. In some embodiments, the buck converter can be operated at or near resonance frequency of the tank inductor and the output capacitor.

In still further embodiments, the step-down voltage converter stage 308 can be implemented in another manner; it is appreciated that the example topology described above is merely one example of a suitable or appropriate step-down voltage converter.

For example, in another embodiment, the high-side lead of the tank inductor is coupled to a low-side lead of the output capacitor, which, in turn, is connected in parallel to the resonant inverter stage 310. The return diode couples a low-side lead of the tank inductor to a high-side lead of the output capacitor. The voltage-controlled switch couples the low-side lead of the tank inductor to a ground reference of the buck converter. This topology is referred to herein as a “low-side” buck converter as a consequence of the connection between the voltage-controlled switch and the input voltage ground reference. In some cases, a step-down voltage converter stage 308 may be implemented with a high-side buck converter in order to have the same ground reference between the rippled direct current ground (connected to the resonant inverter stage 310) and the output ground of the step-down voltage converter stage 308.

In many examples, the output of the step-down voltage converter stage 308 of the power converter 300 is rippled direct current having a voltage defined by the duty cycle at which the step-down voltage converter stage 308 is operated.

The step-down voltage converter stage 308 is typically operated with peak-current control. A sense resistor (not shown) can be used to determine a current flowing through the step-down voltage converter stage 308 in order to determine when to transition the voltage-controlled switch to an off-state. Peak-current control can be implemented in any suitable manner, several of which are described in reference to FIGS. 4A-4C. It may be appreciated that peak-current control may provide current overload and/or overvolt protection to one or more components of the power converter 300, whether such components or stages are associated with the transmitter side or the receiver side of the wireless power transfer stage.

As noted above, the output of the step-down voltage converter stage 308 is coupled to a high-frequency inverter, identified as the resonant inverter stage 310. The resonant inverter stage 310 receives regulated direct current voltage from the step-down voltage converter stage 308 and toggles the conduction state of voltage-controlled switches associated with a half-bridge that is coupled to a resonant circuit including a primary coil 312 and a resonant capacitor. As noted above, the resonant inverter stage 310 is typically configured to operate at a fixed switching frequency, but this may not be required.

The primary coil 312 can be magnetically coupled to a secondary coil within a receiver side of the wireless power converter. Two example receiver sides are depicted in FIGS. 3B-3C. More specifically, FIG. 3B depicts a receiver side 314a that includes a secondary coil 316. The secondary coil 316 provides output to a full-bridge rectifier which, in turn, drives a load.

Similar to FIG. 3B referenced above, FIG. 3C depicts a receiver side 314b that includes a secondary coil 316. The secondary coil 316 provides output to a synchronous full-bridge rectifier which, in turn, drives a load. In some examples, this construction may be operated more efficiently than the full-bridge rectifier depicted in FIG. 3B, which may suffer forward voltage drop power losses.

FIG. 4A depicts a simplified schematic diagram of a peak-current controller that can be used with the power converter depicted in FIG. 3A. The peak-current controller 400 can receive input that corresponds to current through the tank inductor of the step-down voltage converter stage 308 as shown in FIG. 3A.

More specifically, the tank inductor current (or a voltage corresponding to that current) can be compared by a comparator 402 to a reference current input that corresponds to a maximum current permitted to circulate through the tank inductor of the step-down voltage converter stage 308 as shown in FIG. 3A. The output of the comparator 402 can be coupled to the reset input of a flip-flop 406 that is coupled to a controller (not shown) configured to change the conduction state of the voltage-controlled switch of the step-down voltage converter stage 308 as shown in FIG. 3A.

In addition, the inductor current can be compared to a ground reference by a comparator 404. The output of the comparator 404 can be coupled to the set input of the flip-flop 406. In this embodiment, the comparator 402 toggles the conduction state of the voltage-controlled switch when inductor current exceeds a threshold value, whereas the comparator 404 toggles the conduction state of the voltage-controlled switch when the current through the tank inductor crosses zero. In another phrasing, the comparator 402 facilitates peak-current control for the step-down voltage converter stage 308 and the comparator 404 facilitates zero-current switching of the voltage-controlled switch.

In some cases, the reference current input can be fixed, such as shown in FIG. 4B whereas in others, the reference current input can be variable following the unregulated alternating current input (e.g., mains voltage), such as shown in FIG. 4C.

In many cases, reference current input is periodic and in-phase with the unregulated alternating current input to the rectifier. For example, a phase-lock loop can be used to control and/or define the envelope of the reference current input. In this manner, the associated step-down voltage converter stage (e.g., the step-down voltage converter stage 308) approaches unity power factor; the input current is substantially in phase with the alternating current input voltage phase, while the step-down voltage converter stage regulates that voltage to a constant direct current voltage. In many cases, the phase and/or envelope of the reference current input is controlled by a reference current controller, or a current-limiting controller. The current-limiting controller can be configured to match the phase of the current input with a voltage waveform to increase power factor. In some cases, the input current can be phase-locked to the unregulated input voltage (e.g., mains voltage). In further embodiments, the current-limiting controller (and/or other components of the transmitter side) can be configured to respond to signals sent from the receiver side. Such signals can include instructions to increase power transferred, to decrease power transferred, to change frequency, and so on.

As noted above, a resonant inverter stage of a power converter—incorporating a wireless power transfer stage—such as described with reference to FIGS. 3A-4C can be fixed. In other words, the resonant frequency of the primary coil and the secondary coil of the wireless power transfer stage can be selected for optimal performance at a wide variety of coupling factors (e.g., poor coupling between the primary coil and the secondary coil, good coupling between the primary coil and the secondary coil, ideal coupling between the primary coil and the secondary coil, and so on) and at a wide variety of load impedance across the leads of the secondary coil.

The optimal resonant frequency—or a resonant frequency that is close to optimal for a wide variety of operational conditions (e.g., variable coupling factors, variable receiver-side load impendence, and so on) can be selected in a number of ways, for example by modeling the wireless power converter as a circuit of elements have impedance characteristics that are functions of variables such as switching frequency, turns ratio between the primary coil and secondary coil, coupling factor between the primary coil and the secondary coil, and so on.

Once the switching frequency is determined using a suitable method, the values for the resonant capacitors associated with the primary coil and the secondary coil can be determined as well. More specifically, the resonant capacitors are selected such that the leakage inductances of the primary coil and the secondary coil resonate at the driving frequency.

The foregoing embodiments depicted in FIGS. 3A-4C and the various alternatives thereof and variations thereto are presented, generally, for purposes of explanation, and to facilitate an understanding of various possible techniques for standardizing the gain across a wireless power converter substantially independent of coupling quality between a primary coil and a secondary coil and substantially independent of load. However, it will be apparent to one skilled in the art that some of the specific details presented herein may not be required in order to practice a particular described embodiment, or an equivalent thereof.

Still further embodiments can be implemented or can be configured to operate in a different manner. More specifically, a power converter such as described herein can be configured to include a step-up power converter stage integrated with a resonant inverter stage. As a result of the integration of two power conversion stages, fewer components may be required to implement the power converter.

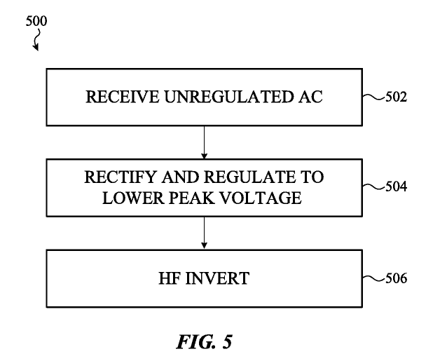

FIG. 5 is a simplified flow chart corresponding to a method of operating a power converter including a wireless power transfer stage, such as described herein. The method 500 begins at operation 502 in which unregulated alternating current is received (e.g., mains voltage). Next, at operation 504, the received current is rectified and regulated to a lower peak voltage. Finally, at operation 506, the rectified and regulated current is inverted at a selected frequency.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

What is claimed is:

1. A power converter comprising:
a rectifier stage accommodated in an enclosure and configured to receive mains voltage;
a step-down voltage converter stage accommodated in the enclosure and configured to receive a rectified voltage from the rectifier stage;
a current-limiting controller operably coupled to the step-down voltage converter stage, accommodated in the enclosure, and configured to limit current output from the step-down voltage converter stage; and
an inverter stage accommodated in the enclosure and configured to receive a lowered regulated voltage from the step-down voltage converter stage.

2. The power converter of claim 1, further comprising:
a wireless power transfer stage comprising a primary coil accommodated in the enclosure and configured to receive an alternating current from the inverter stage.

3. The power converter of claim 1, wherein the current-limiting controller is configured to cause the step-down voltage converter stage to output current that is substantially in phase with mains voltage.

4. The power converter of claim 1, wherein the current-limiting controller is configured to cause the step-down voltage converter stage to output current following a rectified sinusoidal waveform.

5. The power converter of claim 1, wherein the current-limiting controller is configured to cause the step-down voltage converter stage to output periodic current.

6. The power converter of claim 1, wherein the current-limiting controller is configured to cause the step-down voltage converter stage to output current following a direct current reference.

7. The power converter of claim 1, wherein the enclosure is a low-profile enclosure formed at least in part from plastic or glass.

8. The power converter of claim 1, wherein the wireless power stage further comprises a secondary coil accommodated within a second enclosure and configured to receive a second alternating current from the primary coil.

9. The power converter of claim 8, wherein the primary coil and the secondary coil are configured to resonate at a selected frequency.

10. A power converter comprising:
an enclosure;
a rectifier stage configured to receive mains voltage;
a buck converter stage configured to receive a rectified voltage from the rectifier stage;
an inverter stage configured to receive a lowered regulated voltage from the buck converter stage; and
a controller configured to limit current output from the buck converter stage based on a waveform in phase with mains voltage.

11. The power converter of claim 10, wherein the enclosure defines a surface configured to support an electronic device comprising a secondary coil.

12. The power converter of claim 11, wherein the inverter stage comprises a primary coil configured to magnetically couple to the secondary coil through the enclosure.

13. The power converter of claim 12, wherein the enclosure isolates mains voltage from the electronic device.

13. The power converter of claim 12, wherein the primary coil and the secondary coil are separated by a gap that isolates mains voltage from the electronic device.

14. The power converter of claim 10, wherein the electronic device is a cellular phone or a wearable electronic device.

15. The power converter of claim 10, wherein the enclosure accommodates the rectifier stage, the buck converter stage, the controller, and the inverter stage.

16. The power converter of claim 10, wherein the primary coil and the secondary coil are configured to resonate at a selected frequency.

17. A method of converting power comprising:
receiving, at a rectifier, mains voltage at a first frequency and a first voltage;
receiving, at a voltage converter, a rectified voltage from the rectifier;
limiting, by a controller, current output from the voltage converter based on a waveform in phase with mains voltage;
receiving, at an inverter, a regulated voltage from the voltage converter; and
outputting, from the inverter, power at the regulated voltage at a second frequency.

18. The method of claim 17, wherein the second frequency is greater than the first frequency.

19. The method of claim 17, further comprising applying power output from the inverter to a transmit coil of a wireless power transmitter.

20. The method of claim 17, wherein the waveform is based on the rectified voltage.
